(19) United States
(12) Patent Application Publication
(10) Pub. No.: US 2014/0320253 A1
(43) Pub. Date: Oct. 30, 2014

(54) TRANSFORMER-CORE

(71) Applicant: ABB Technology AG, Zurich (CH)

(72) Inventors: Martin CARLEN, Niederrohrdorf (CH); Benjamin Weber, Winterberg (DE); Burak Esenlik, Paderborn (DE); Stephane Schaal, Sierentz (FR); Jens Tepper, Brilon (DE); Jong-Yun Lim, Chungchongnam-do (KR)

(73) Assignee: ABB Technology AG, Zurich (CH)

(21) Appl. No.: 14/330,245

(22) Filed: Jul. 14, 2014

Related U.S. Application Data
(63) Continuation of application No. PCT/EP2012/005059, filed on Dec. 7, 2012.

(30) Foreign Application Priority Data
Jan. 18, 2012 (EP) 12000263.9

(51) Int. Cl. H01F 27/24

(52) U.S. Cl. CPC H01F 27/24
USPC 336/212

(57) ABSTRACT

A transformer core is disclosed, which can include at least three hollow-cylindrical rectangular shaped core-discs wound from a magnetic band-like material, wherein two opposed limb areas and an upper and lower yoke area can be formed along a circumferential path. The core-discs can include one first and at least one second slanted area parallel to the circumferential path in the belonging limb area. The at least three core-discs can be connected according to a polygonal layout at their first slanted areas, which can be arranged adjacently face to face. Conical shaped polygonal adapter plates fitted to the polygonal layout within the upper and lower yoke areas, which can be clamped together.

### RELATED APPLICATION(S)

This application claims priority as a continuation application under 35 U.S.C. §120 to PCT/EP2012/005059, which was filed as an International Application on Dec. 7, 2012 designating the U.S., and which claims priority to European Application 12000263.9 filed in Europe on Jan. 18, 2012. The entire contents of these applications are hereby incorporated by reference in their entireties.

### FIELD

The disclosure relates to a transformer core, which can include at least three hollow-cylindrical rectangular shaped core-discs wound from a magnetic band-like material, wherein two opposed limb areas and an upper and lower yoke area can be formed along a circumferential path, the core-discs can include one first and at least one second slanted area parallel to the circumferential path in the limb area and wherein the at least three core-discs can be connected according to a polygonal layout at their first slanted areas, which can be arranged adjacently face to face.

### BACKGROUND INFORMATION

Transformers for power transmission rated for voltage levels of, for example, 10 kV, 60 kV 110 kV or above, are known, whereas the rated power amounts can be, for example, 1 MVA, 10 MVA or even 100 MVA. Transformer cores for such transformers can be based on stacked metal sheets of a thickness of, for example, 0.2 mm to 0.3 mm due to a permanent magnetic re-orientation during operation of such transformer core magnetic losses can be produced, which can also have a heating effect on the transformer core.

It is also known, that a transformer core can be made from an amorphous material, which can provide reduced core-losses in comparison to a standard transformer core. Amorphous material can be a band-like refractory material, which can be sensitive against mechanical stress and can have a thickness of, for example, 30 μm or less. An amorphous transformer core can be wound from such a band-like material, and the width of such band can amount, for example, 30 cm, and whereas several thousand layers can be wound. A wound amorphous transformer core can be sensitive to mechanical stress produced, for example, by mechanical collisions. In addition, the wearing of the weight of the transformer can cause mechanical stress.

Transformer cores of an amorphous material can be cooled during operation, for example, since reduced core losses can be gained in a temperature range of lower than 140°, otherwise the core losses increase. Due to the high fragility of an amorphous transformer core and the limitation of the available width of the band-like amorphous material, the maximum rated power of a transformer with amorphous transformer core can currently be limited to about 10 MVA.

It is also known, that transformer cores can be constructed according to a polygonal layout, which can be a three-phase transformer according to a triangular layout. Due to the symmetrical construction, the electrical behavior of such a transformer can be symmetrical, which can produce a more compact and space-saving arrangement. A polygonal respectively triangular transformer core can have reduced stability, for example, for transformer cores formed by core discs. Core discs can be relatively easier to manufacture, however, core discs can be more fragile due to the slanted areas and the obtaining of a mechanically stable connection of adjacent core discs can be difficult.

Known transformer cores with polygonal layout can have reduced stability and for an amorphous transformer core, which can be made from a wound band-like amorphous material, the transformer cores can have a fragile structure.

### SUMMARY

A transformer core is disclosed, comprising: at least three hollow-cylindrical rectangular shaped core-discs wound from a magnetic band-like material, wherein each of the core-discs includes two opposed limb areas, an upper yoke area, and a lower yoke area formed along a circumferential path, wherein each of the core-discs includes a first and at least one second slanted area parallel to the circumferential path in the two opposed limb areas, and wherein the at least three core-discs are configured to be connected according to a polygonal layout at the first slanted areas, which are arranged adjacent to one another; and conical shaped polygonal adapter plates fitted to the polygonal layout within the upper and lower yoke areas.

A transformer is disclosed, the transformer comprising: a transformer core, and three transformer coils, the transformer core having: at least three hollow-cylindrical rectangular shaped core-discs wound from a magnetic band-like material, wherein each of the core-discs includes two opposed limb areas, an upper yoke area, and a lower yoke area formed along a circumferential path, wherein each of the core-discs includes a first and at least one second slanted area parallel to the circumferential path in the two opposed limb areas, and wherein the at least three core-discs are configured to be connected according to a polygonal layout at the first slanted areas, which are arranged adjacent to one another; and conical shaped polygonal adapter plates fitted to the polygonal layout within the upper and lower yoke areas, wherein the three transformer coils, can be arranged around each limb area.

### BRIEF DESCRIPTION OF THE DRAWINGS

The disclosure will now be further explained by means of exemplary embodiments and with reference to the accompanying drawings, in which:

FIG. 1 shows an exemplary core disc;

FIG. 2 shows an exemplary transformer core;

FIG. 3 shows an exemplary transformer core;

FIG. 4 shows an exemplary transformer core;

FIG. 5 shows an exemplary transformer core; and

FIG. 6 shows an exemplary transformer core with a clamping fixture.

### DETAILED DESCRIPTION

A polygonal transformer core is disclosed, for example, which can include an amorphous polygonal transformer core for increased mechanical stability.

In accordance with an exemplary embodiment, conical shaped polygonal adapter plates can be fitted to the polygonal layout within the upper and lower yoke areas, which can be clamped together to each other.

Due to the conical shape of the adapter plates, a plug can be formed within each yoke area, so that a pressure force can be applicable thereon. This pressure force can also increase the mechanical stability of the transformer core.

In accordance with an exemplary embodiment, the polygonal layout of the transformer core can be triangular, such that the layout of conical shaped adapter plate can also be triangular. The thickness of the conical shaped adapter plate can be sufficient that a pressure force in between both opposed adapter plates can be transmittable on both yoke areas. For example, the thickness of the adapter plate can be in a range of 5 cm to 20 cm, which can be dependent on the size of the transformer and the shape and diameter of the yokes to be clamped. A diameter of a yoke can be 30 cm or 40 cm, for example, can be obtained by the conical design of the edges of the adapter plates, so that an axial force between the adapter plates can be split into an axial and a radial force on the yokes of the transformer core. In accordance with an exemplary embodiment, to help withstand the radial forces, the core-discs can be mechanically connected at their limbs, for example, by winding a band or an epoxy resin impregnated glass fibre or such around the composed limbs.

In accordance with an exemplary embodiment, the edges of the conical adapter plates can include an elastic material such as a thermal suitable rubber material, which can have, for example, a thermal resistance higher than 140° C. The pressure force from the adapter plates can be homogenously applied on the wound layers of the yoke on one side, and on the other side any vibrations of the wound layers can be dampened therewith.

The adapter plate can be rather large on one side, but on the other side, the adapter place can be designed similar to a triangle, for example, so that an inner hollow, which can have, for example, a positive effect on the cooling of the transformer core respectively transformer. An axial pressure can be applied in between the opposed adapter plates, so that the transformer core can be clamped between the opposed adapter plates. For example, the transformer core can be clamped between the opposed adapter plates by one or more threaded rods with an upper and a lower screw nut.

The transformer core according to the disclosure, for example, can also be used for a reactor core.

In accordance with an exemplary embodiment, each limb area can include at least one flat plate, which can be connected even and stiff with an adjacent slanted area.

In accordance with an exemplary embodiment, the mechanical stability and stiffness of the transformer core can be increased by connecting a flat plate on a slanted area, which can reduce the mechanical stability compared to a non-slanted area. Thus, the flat plate and the slanted area can be adapted to their basic shape. In accordance with an exemplary embodiment, a bend plate can be connected on a bend slanted area. Due to the design of the core according to a polygonal layout, for example, triangular, the width of the wound magnetic band-like material can vary from layer to layer in a way that a cross section with a non-rectangular shape can be formed. For example, the cross section in the limb area of the core disc can be shaped such that there is no or at least nearly no gap between the first slanted areas of adjacent core discs. Thus, the adjacent core-discs can be relatively easier and more stable to connect on one side and on the other side the magnetic active cross section of a limb, which can be formed by two limb sections of adjacent core-discs, can be increased.

In accordance with an exemplary embodiment, a core disc with round corners, which layout corresponds more to an oval than to a rectangular shape can have a rectangular shaped within the frame of this disclosure. In accordance with an exemplary embodiment, the magnetic band-like material can be comparable to metal sheets of stacked transformer cores and can have a thickness of, for example, about 0.2 mm or 0.3 mm.

In accordance with an exemplary embodiment, the wound magnetic band-like material can be an amorphous material, which can be more fragile than comparable shaped metal sheets. Moreover, the thickness of layers of such amorphous material can be lower, for example, 30 μm or less. Thus, the effect of mechanical stabilization of an amorphous core-disc according to the disclosure can be increased.

In accordance with an exemplary embodiment, at least one plate is connected even and stiff at least on one of their both flat sides with the adjacent slanted area by a glued bond. For example, a glue based connection can be relatively easy to manufacture, and wherein at least most of the layers of the wound band-like material can be fixed therewith. Thus, the glue based connection can help reduce vibration of the layers and increase the mechanical stability. In addition, glue in its liquid state can fill any unevenness on the slanted areas and can enable a mechanical connection with a high mechanical stability. According to an exemplary embodiment of the disclosure, the flat plate can be connected to a slanted area of a core-disc, which can include holes, long-holes, or other cut-outs, which can reduce the weight of the transformer without a reduction of the mechanical stability.

In accordance with an exemplary embodiment, the first slanted areas can be connected even and stiff with a flat plate. The mechanical stabilizing effect of a plate can be highest at the first slanted areas since the connection in between adjacent core-discs can be realized by using those first areas. Such a connection can be, for example, performed by a tape-like material, which can be wound around adjacent core sections of adjacent core-discs so that a permanent pressure force can be applied on adjacent plates.

In accordance with an exemplary embodiment, adjacent first slanted areas can be connected even and stiff to the same plate in between them. Such connection can be, for example, from both sides by a glue bond. In addition, the core for arranging the coil on the transformer limb does not have to be reopened, since the conductor of such a coil can also be wound around a limb of a closed core.

In accordance with an exemplary embodiment, adjacent first slanted areas can be connected even and stiff to individual and stacked plates in between them. Thus, each first area of a transformer-disc can be connected to an individual flat plate, whereas the plates can be arranged face to face, respectively optionally with one or more additional plates in between them. Thus, each core-disc with connected flat plates thereon can be manufactured separately whereas the core-discs can be connected later on, which can simplify the manufacturing process of the transformer core.

In accordance with an exemplary embodiment, the individual and stacked plates can be connected by a glued bond, screws or welding. In accordance with an exemplary embodiment, a screw connection can be resolvable, so that the core can become demounted.

In accordance with an exemplary embodiment, at least one plate can be connected even and stiff to a first slanted area and can extend over the dimension of the first area so that an overlaying area is formed. Since the desired magnetic characteristics of an amorphous transformer core can be dependent on not exceeding a certain temperature range, an adequate cooling of the transformer is desirable. By forming such overlapping areas, an additional surface for heat exchange with the environment can be obtained.

In accordance with an exemplary embodiment, at least one extending plate can be bent in the overlaying area. The mechanical stability of such a plate, for example, can be connected to a first slanted area, can be increased once again. Furthermore, an additional cooling effect can be obtained with less space.

The cross sections of the yokes can be shaped in a comparable way than the limbs and arrange plates thereon. The advantages of those plates can be comparable to the advantages connected to slanted areas at the limb sections.

In accordance with an exemplary embodiment, the limbs formed in the limb areas can be surrounded by second slanted areas which can be connected even and stiff with plates. Connecting also the second slanted areas, which can be forming the outer surface of a limb composed from two limb areas, can additionally increase the mechanical stability of the transformer core. Furthermore, a mechanical protection of the limb can be provided therewith. Such a protection can be of interest, if the conductor of a coil is wound around the limb of a manufactured transformer coil. For example, in this case, rotating movement can be applied on the coil to be wound, which can slide on the surface of the limb. The limb can be protected against such a sliding movement therewith.

In accordance with an exemplary embodiment, adjacent second slanted areas can be connected with a common plate, which can provide evenness and stiffness to the core discs and transformer core. Thus, a common plate can overlap slanted areas of adjacent core-discs so that the mechanical connection of the core-discs can be improved therewith. According to an exemplary embodiment of the disclosure, the common plate can be bent, so that an angle in between two adjacent slanted areas can be compensated therewith. In accordance with an exemplary embodiment, an electrical conducting loop around the circumference of the limb, which can be built by adjacent plates should be avoided, to avoid forming a short-circuit current there through.

In accordance with an exemplary embodiment, the at least one plate consists at least predominantly of stainless steel. Stainless steel has a relatively high mechanical stability and can easily become glued together with slanted areas of the amorphous transformer core.

In accordance with an exemplary embodiment, at least one of the glued bonds can include a fibre structure. During manufacturing, a glued bond can be applied in the wet state, so that a mat of, for example, glass fibre can be arranged therein. Glass fibres can increase the mechanical strength of the glued bond and of the transformer core therewith.

In accordance with an exemplary embodiment, a transformer is disclosed, which includes a transformer core according to the disclosure and at least three transformer coils, which can be arranged around each limb area. The transformer as disclosed can reduce core losses and can have an increased efficiency factor therewith. The transformer core furthermore provides an increased mechanical stability of the transformer, so that as well the transport as the arrangement on site can be improved therewith.

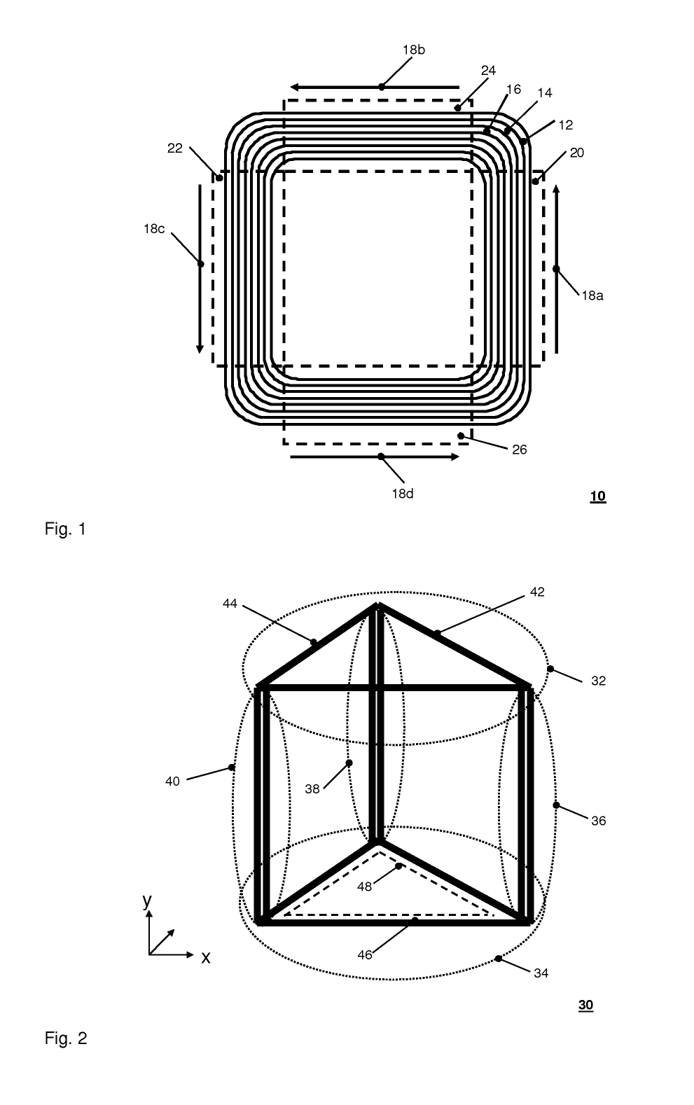

FIG. 1 shows an exemplary core disc 10 from a wound amorphous band-like material, wherein different layers can be indicated with the reference numbers 12, 14, 16. The core disc 10 can include, for example, several thousand of those layers. The core disc 10 can be a hollow-cylindrical and rectangular shaped, whereas a core disc with round corners, which layout corresponds more to an oval than to a rectangular shape, can also be seen as rectangular shaped within the frame of this disclosure. The core disc can consist of two opposed limb areas 20, 22 an upper 24 and a lower 26 yoke area, which can be arranged along a circumferential path 18a, 18b, 18c, 18d. Slanted areas are not explicitly visible in this drawing.

FIG. 2 shows a schematic illustration of an exemplary transformer core 30 in a simplified three-dimensional sketch. Three exemplary core discs 42, 44, 46 can be arranged according to a polygonal respectively triangular layout 48. Three limb areas 36, 38, 40 can be formed by sections of two adjacent core discs 42, 44, 46 each. The limb areas 36, 38, 40 can be foreseen to arrange a coil of the transformer around them. An upper 32 and lower 34 yoke area can be formed by the upper respectively lower yokes of the adjacent core discs 42, 44, 46. In accordance with an exemplary embodiment, the triangular arrangement can correspond to an equilateral triangle.

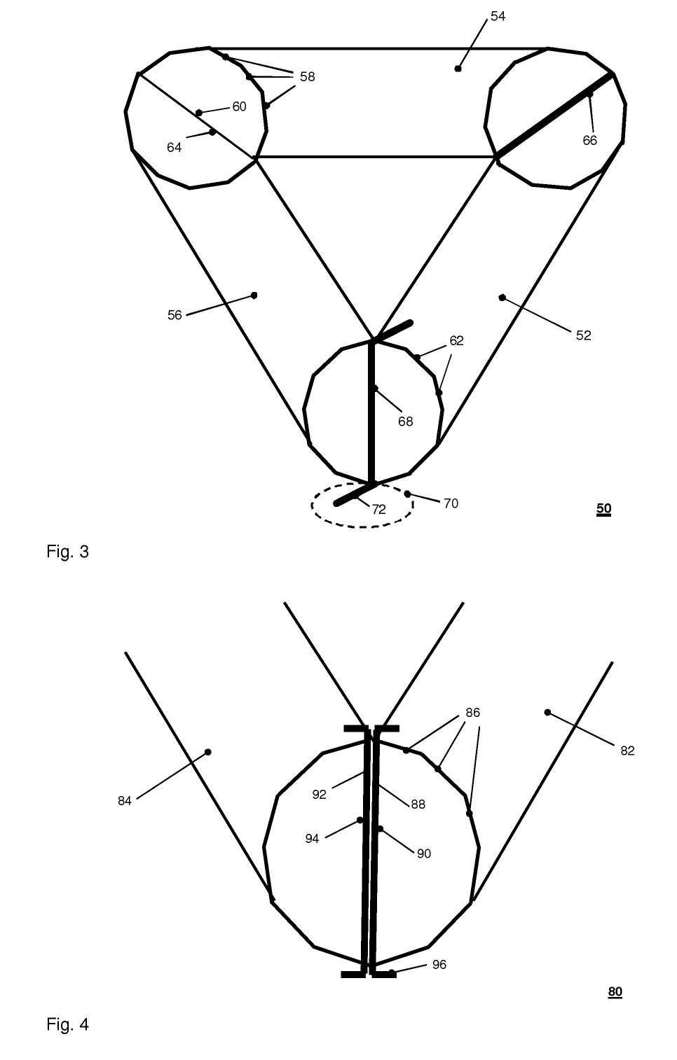

FIG. 3 shows an exemplary transformer core 50 from a top view and partly as a cross section. Three core discs 52, 54, 56 can be arranged according to an equilateral triangular layout. The cross sections of the core discs 52, 54, 56 can be included within their limb areas second slanted areas 58, 62, which can form the outside surface of the composed limb. First slanted areas 60, 64 can be arranged face to face. The face to face arrangement of the first slanted areas 60, 64 can enable, for example, putting a pressure force thereon, so that a mechanical connection of the core discs 52, 54, 56 can be simplified therewith. In accordance with an exemplary embodiment, an exemplary first plate 66 can be arranged in between two adjacent first slanted areas of the transformer discs 52, 54, 56. The plate 66 can be, for example, connected by a glued bond with the first slanted areas. An exemplary second plate 68 can be in between two adjacent other first slanted areas. The plate 68 can consist of bent section 72, so that an overlaying area 70 can be formed, which is on one side stabilizing the mounted transformer core and which on the other side has a cooling effect on the transformer core. The arrangement of the plates 66, 68 for the transformer core 50, for example, can be arranged symmetrically.

FIG. 4 shows an exemplary transformer core 80 from a top view and partly as cross section. Two core discs 82, 84 can be arranged adjacently face to face at their first slanted areas 90, 94, whereas also second slanted areas 86 can be at the outside surface of the composed limb. On each of both first slanted areas 90, 94, a U-shaped plates 88, 92 can be connected with a glued bond. The U-shape, indicated, for example, by a bent section 96, can improve the mechanical stability of the transformer core 80.

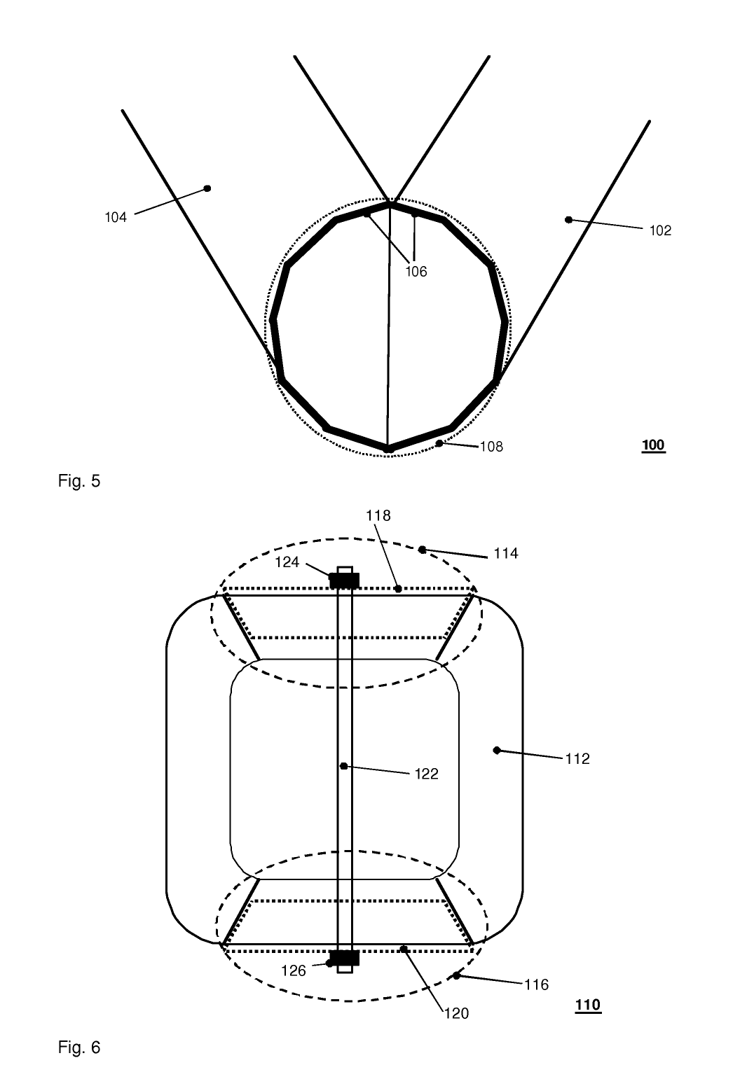

FIG. 5 shows an exemplary transformer core 100 from a top view and partly as a cross section. Two core discs 102, 104 can be arranged adjacently face to face at their first slanted areas. A composed limb can be formed by the sections of the core discs 102, 104 and can be surrounded by a virtual path, which is indicated with the reference number 108. Common bent plates 106 can be along the path 108 and connected with second slanted areas of the composed limb, for example, with a glued bond. The mechanical connection of the core discs 102, 104 can be increased therewith. Furthermore, the composed limb can be mechanically protected by plates 106, for example, if a coil is wound around such a limb of a mounted transformer core during manufacturing.

FIG. 6 shows an exemplary transformer core 110 with a clamping fixture 118, 120, 122, 124, 126 from a side view. A core disc 112 from a magnetic wound band-like material is shown from its side, whereas two other core discs, which all three can be mounted together to a transformer core, are not shown. An upper 114 and lower 116 yoke area can be formed by the three upper and lower yokes of the core discs. Conical shaped upper 118 and lower 120 adapter plate can be inserted in the inner yoke areas 114, 116, respectively, whereas adapter plates 118, 120 and inner yoke areas 114, 116 can be adapted concerning their shapes. Thus, a pressure force can be applied in between both adapter plates 118, 120, which clamps them together. For example, the pressure force can be applied by a threaded rod 122 with upper 124 and lower screw nut. In accordance with an exemplary embodiment, applying such a pressure force can increase the mechanical stability of the transformer core 110.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SIGNS

10 exemplary first core disc
12 first layer of amorphous band-like material
14 second layer of amorphous band-like material
16 third layer of amorphous band-like material
18a first section of circumferential path
18b second section of circumferential path
18c third section of circumferential path
18d fourth section of circumferential path
20 first limb area of first core disc
22 second limb area of first core disc
24 upper yoke area of first core disc
26 lower yoke area of first core disc
30 exemplary first transformer core
32 upper yoke area of first transformer core
34 lower yoke area of first transformer core
36 first limb area (first and third core disc)
38 first limb area (first and second core disc)
40 first limb area (second and third core disc)
42 first core disc of first transformer core
44 second core disc of first transformer core
46 third core disc of first transformer core
48 polygonal layout
50 exemplary second transformer core
52 first core disc of second transformer core
54 second core disc of second transformer core
56 third core disc of second transformer core
58 second slanted areas of second core disc
60 first slanted area of second core disc
62 second slanted areas of first core disc
64 first slanted area of third core disc
66 first plate of second transformer core
68 second plate of second transformer core
70 overlaying area
72 bent section of second plate
80 exemplary third transformer core
82 first core disc of third transformer core
84 second core disc of third transformer core
86 second slanted areas of first core disc
88 first plate connected with first slanted area of first core disc
90 first slanted area of first core disc
92 second plate connected with first slanted area of second core disc
94 first slanted area of second core disc
96 bent section of first plate
100 exemplary fourth transformer core
102 first core disc of fourth transformer core
104 second core disc of fourth transformer core
106 common bent plate of adjacent second areas
108 surrounding path of formed limb
110 exemplary fifth transformer core with clamping fixture
112 first core disc of fifth transformer core
114 upper yoke area of fifth transformer core
116 lower yoke area of fifth transformer core
118 conical shaped polygonal upper adapter plate
120 conical shaped polygonal lower adapter plate
122 threaded rod
124 upper screw nut
126 lower screw nut

What is claimed is:

1. A transformer core, comprising:
at least three hollow-cylindrical rectangular shaped core-discs wound from a magnetic band-like material, wherein each of the core-discs includes two opposed limb areas, an upper yoke area, and a lower yoke area formed along a circumferential path, wherein each of the core-discs includes a first and at least one second slanted area parallel to the circumferential path in the two opposed limb areas, and wherein the at least three core-discs are configured to be connected according to a polygonal layout at the first slanted areas, which are arranged adjacent to one another; and
conical shaped polygonal adapter plates fitted to the polygonal layout within the upper and lower yoke areas.

2. The transformer core according to claim 1, wherein the conical shaped polygonal adapter plates are clamped to the upper and lower yoke areas.

3. The transformer core according to claim 1, wherein the magnetic band-like material is an amorphous material.

4. The transformer core according to claim 1, comprising:
at least one flat plate in each of the two opposed limb areas, which is configured to be connected to the first and the at least one second slanted areas.

5. The transformer core according to claim 4, wherein the at least one plate is connected with the first and the at least one second slanted areas by a glued bond.

6. The transformer core according to claim 1, comprising:
at least one flat plate configured to be connected to the first slanted area of each of the core-discs.

7. The transformer core according to claim 6, wherein the adjacent first slanted areas of each of the core-discs are configured to be connected to the at least one flat plate.

8. The transformer core according to claim 6, wherein the adjacent first slanted areas are configured to be connected to a pair of plates between the adjacent first slanted areas.

9. The transformer core according to claim 8, comprising:
a glued bond, screws, or a weld, which is configured to connect the pair of plates to the adjacent first slanted areas.

10. The transformer core according to claim 6, wherein the at least one flat plate is configured to extend over the dimension of the first slanted area so that an overlaying area of the at least one flat plate is formed.

11. The transformer core according to claim 10, wherein the overlaying area is bent.

12. The transformer core according to claim 4, wherein the two opposed limbs formed in the limb areas are surrounded by the second slanted areas and are configured to be connected with a plate.

13. The transformer core according to claim 12, wherein the adjacent second slanted areas are configured to be connected with a common plate.

14. The transformer core according to claim 13, wherein the common plate is bent.

15. The transformer core according to claim 5, wherein the glued bond comprises:
a fibre structure.

16. A transformer, the transformer comprising:
a transformer core, and three transformer coils, the transformer core having:
at least three hollow-cylindrical rectangular shaped core-discs wound from a magnetic band-like material, wherein each of the core-discs includes two opposed limb areas, an upper yoke area, and a lower yoke area formed along a circumferential path, wherein each of the core-discs includes a first and at least one second slanted area parallel to the circumferential path in the two opposed limb areas, and wherein the at least three core-discs are configured to be connected according to a polygonal layout at the first slanted areas, which are arranged adjacent to one another; and
conical shaped polygonal adapter plates fitted to the polygonal layout within the upper and lower yoke areas, wherein the three transformer coils, can be arranged around each limb area.

17. The transformer according to claim 16, wherein the conical shaped polygonal adapter plates are clamped to the upper and lower yoke areas.

18. The transformer according to claim 16, wherein the magnetic band-like material is an amorphous material.

19. The transformer according to claim 16, comprising:
at least one flat plate in each of the two opposed limb areas, which is configured to be connected to the first and the at least one second slanted areas.

20. The transformer according to claim 19, wherein the two opposed limbs formed in the limb areas are surrounded by the second slanted areas and are configured to be connected with a plate.
